(19) United States
(12) Patent Application Publication
(10) Pub. No.: US 2011/0135947 A1
(43) Pub. Date: Jun. 9, 2011

(54) Masking Material, Masking Layer, Process for Masking a Substrate and Process for Coating a Substrate

(76) Inventors: Thomas Berndt, Berlin (DE); Francis-Jurjen Ladru, Berlin (DE)

(21) Appl. No.: 12/958,521

(22) Filed: Dec. 2, 2010

(30) Foreign Application Priority Data
Dec. 4, 2009 (EP) 09015078.0

(51) Int. Cl. B32B 15/04; B05D 1/12; B05D 1/18; B05D 1/28; B05D 1/36; B05D 5/00; B32B 18/00; C04B 35/00; C04B 35/46; C04B 35/443; C04B 35/465; C04B 35/10

(52) U.S. Cl. 428/450; 427/203; 501/1; 501/134; 501/153; 501/136; 501/151

(57) ABSTRACT

A two-layer system made of ceramic powder and metallic powder is provided. The ceramic powder may include zirconium oxide, aluminum oxide, titanium oxide, a perovskite, a spindle, a pyrochore and/or boron nitride and mixtures thereof. The metallic powder may include nickel, aluminum, cobalt and/or chromium, and mixtures or alloys thereof. A masking layer and a process for masking a substrate are also provided.

### CROSS REFERENCE TO RELATED APPLICATIONS

This application claims priority of European Patent Office application No. 09015078.0 EP filed Dec. 4, 2009, which is incorporated by reference herein in its entirety.

### FIELD OF INVENTION

The invention relates to a masking material, to a process for masking and to a process for coating.

### BACKGROUND OF INVENTION

In coating processes, particularly in those which use a vapor phase, such as the PVD or CVD process, it is necessary to provide particularly effective gas-tight protection of specific regions, because no coating is to be applied at these points.

Various processes are known in which powder mixtures of various sizes are mixed together mechanically or glass-containing substances are applied; these should be particularly tight, but are difficult to remove again.

### SUMMARY OF INVENTION

It is therefore an object of the invention to solve the above-mentioned problem.

The object is achieved by a masking material as claimed in the claims, by a masking layer as claimed in the claims, by a process for masking as claimed in the claims and by a process for coating as claimed in the claims.

### BRIEF DESCRIPTION OF THE DRAWINGS

FIG. 1 shows a schematic sequence of the process for masking a substrate,

FIGS. 2, 3 show a coating process,

FIG. 4 shows a perspective view of a turbine blade or vane,

FIG. 5 shows a perspective view of a gas turbine, and

FIG. 6 shows a list of superalloys.

The figures and the description represent merely exemplary embodiments of the invention.

### DETAILED DESCRIPTION OF INVENTION

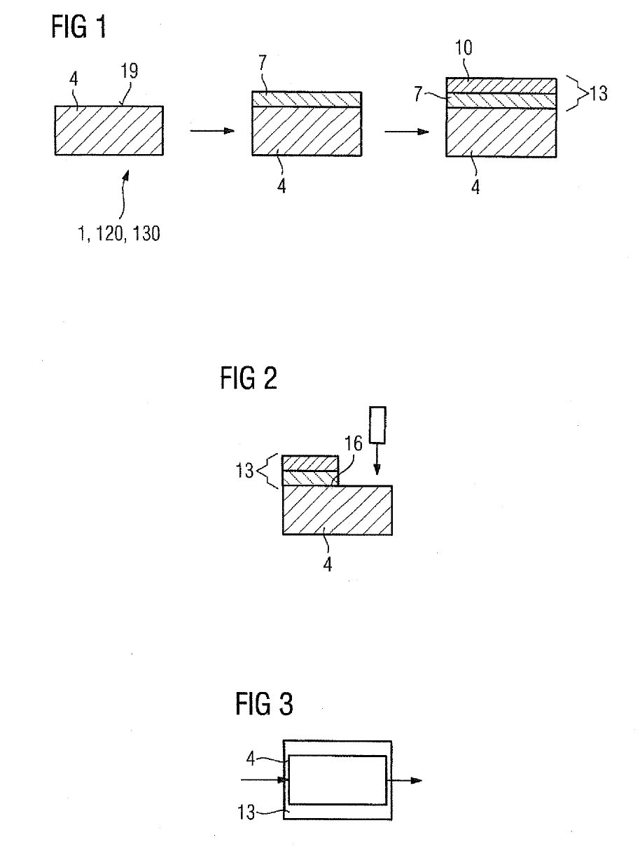

FIG. 1 shows a substrate 4 having a surface 19, which represents a substrate of a component 1, 120, 130.

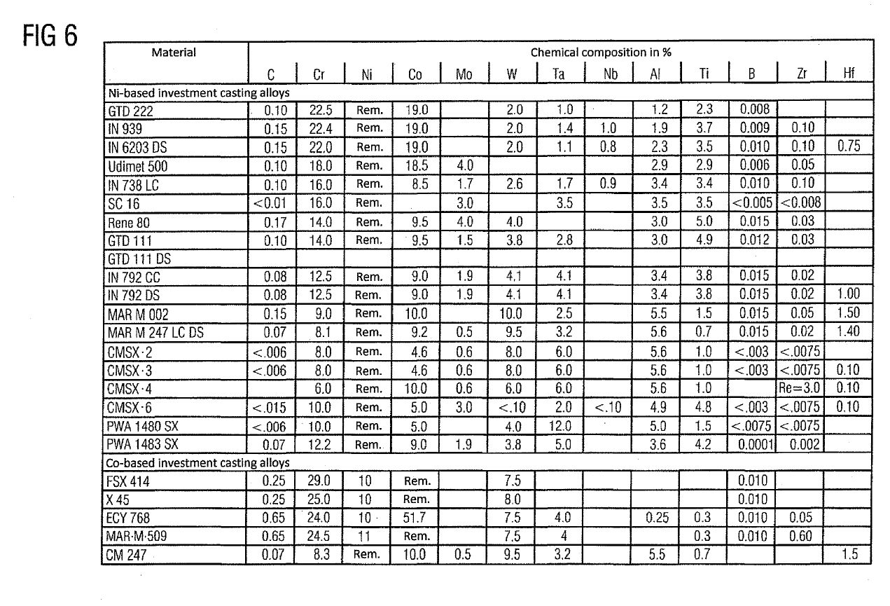

In particular in the case of gas turbines 100 (FIG. 5), this is a turbine blade or vane which is formed, in particular, from materials as shown in FIG. 6.

In a first step, a ceramic powder is preferably applied as a layer 7 to the surface 19.

The ceramic powder may be applied by spraying or by other processes with or without a binder.

The ceramic powder may comprise, in particular, an oxide ceramic, zirconium oxide, aluminum oxide, titanium oxide,

a perovskite, a spinel, a pyrochlore and/or boron nitride or mixtures thereof; use is made very particularly of aluminum oxide or titanium oxide (TiO₂).

It is preferable to use only one ceramic, very particularly only Al₂O₃.

It is preferable to use a mixture of Al₂O₃/TiO₂ or ZrO₂/TiO₂ or Al₂O₃/ZrO₂ or BN/TiO₂ or BN/Al₂O₃ or BN/ZrO₂.

The mixture ratios are preferably 93/7 or 87/13.

In a second process step, a metallic powder is preferably applied as a layer 10 to the ceramic powder layer 7.

Said powder may also penetrate partially into the open pores of the ceramic layer 7.

These layers together form a masking layer 13.

These two steps can also preferably be repeated at least once, in particular only once, so as to produce a multi-layer masking layer 13: ceramic-metal-ceramic-metal.

One ceramic layer and one metallic layer are preferably sufficient.

Even better results are obtained with graduated transitions between the ceramic and metal.

The metallic powder is, in particular, a metal of the substrate, i.e. preferably nickel (Ni), cobalt (Co), chromium (Cr), aluminum (Al) or mixtures thereof, which can preferably react favorably with a coating material. Use is made, in particular, of nickel.

It is also possible to use an alloy of the above-mentioned metals (NiAl, . . . ).

In general, the grain size distribution is preferably as follows:

in the ceramic powder: 0.1 μm-20 μm (100 nm-20 μm),
in the metallic powder: 5 μm-25 μm (1 μm-25 μm).

This layer system comprising the lower ceramic powder layer and the upper metallic powder layer 10 forms a masking layer 13 which is, in particular, gas-tight.

Such a masking layer 13 can be applied locally to points 16 where no coating is to take place (FIG. 2).

In this respect, the masking material can be used for any desired coating processes, particularly however for vapor deposition coating processes, such as for example PVD, CVD or other processes in which the coating material is present in a vapor or gas form.

It is likewise possible for the entire outer substrate 4 to be protected if, for example, a hollow component is internally coated, e.g. chromized or aluminized, and it cannot always be prevented that coating material leaves the hollow component again and becomes deposited on unprotected outer surfaces of the substrate 4.

A mechanical mixture of ceramic powder and metallic powder comprising the above-listed preferred materials and applied by the above-listed preferred processes can likewise be used as the masking material.

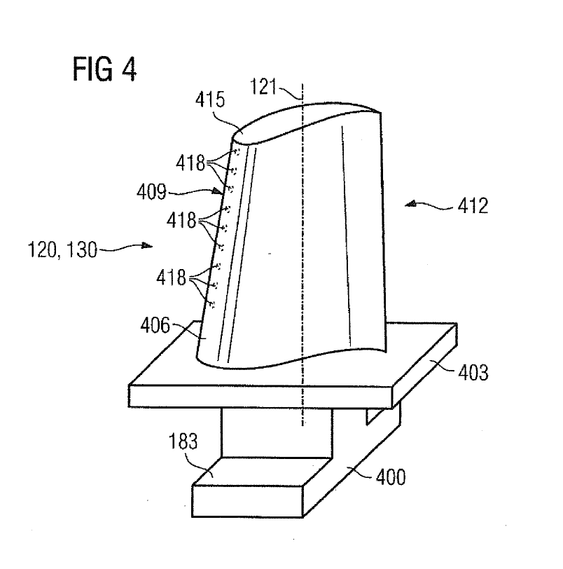

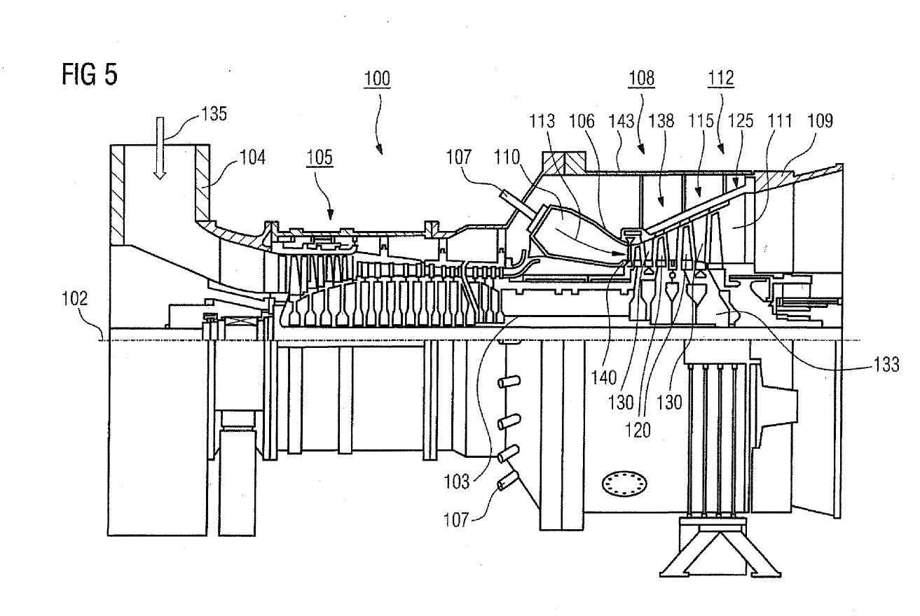

FIG. 4 shows a perspective view of a rotor blade 120 or guide vane 130 of a turbomachine, which extends along a longitudinal axis 121.

The turbomachine may be a gas turbine of an aircraft or of a power plant for generating electricity, a steam turbine or a compressor.

The blade or vane 120, 130 has, in succession along the longitudinal axis 121, a securing region 400, an adjoining blade or vane platform 403 and a main blade or vane part 406 and a blade or vane tip 415.

As a guide vane 130, the vane 130 may have a further platform (not shown) at its vane tip 415.

A blade or vane root 183, which is used to secure the rotor blades 120, 130 to a shaft or a disk (not shown), is formed in the securing region 400.

The blade or vane root 183 is designed, for example, in hammerhead form. Other configurations, such as a fir-tree or dovetail root, are possible.

The blade or vane 120, 130 has a leading edge 409 and a trailing edge 412 for a medium which flows past the main blade or vane part 406.

In the case of conventional blades or vanes 120, 130, by way of example solid metallic materials, in particular superalloys, are used in all regions 400, 403, 406 of the blade or vane 120, 130.

Superalloys of this type are known, for example, from EP 1 204 776 B1, EP 1 306 454, EP 1 319 729 A1, WO 99/67435 or WO 00/44949.

The blade or vane 120, 130 may in this case be produced by a casting process, by means of directional solidification, by a forging process, by a milling process or combinations thereof.

Workpieces with a single-crystal structure or structures are used as components for machines which, in operation, are exposed to high mechanical, thermal and/or chemical stresses.

Single-crystal workpieces of this type are produced, for example, by directional solidification from the melt. This involves casting processes in which the liquid metallic alloy solidifies to form the single-crystal structure, i.e. the single-crystal workpiece, or solidifies directionally.

In this case, dendritic crystals are oriented along the direction of heat flow and form either a columnar crystalline grain structure (i.e. grains which run over the entire length of the workpiece and are referred to here, in accordance with the language customarily used, as directionally solidified) or a single-crystal structure, i.e. the entire workpiece consists of one single crystal. In these processes, a transition to globular (polycrystalline) solidification needs to be avoided, since non-directional growth inevitably forms transverse and longitudinal grain boundaries, which negate the favorable properties of the directionally solidified or single-crystal component.

Where the text refers in general terms to directionally solidified microstructures, this is to be understood as meaning both single crystals, which do not have any grain boundaries or at most have small-angle grain boundaries, and columnar crystal structures, which do have grain boundaries running in the longitudinal direction but do not have any transverse grain boundaries. This second form of crystalline structures is also described as directionally solidified microstructures (directionally solidified structures).

Processes of this type are known from U.S. Pat. No. 6,024,792 and EP 0 892 090 A1.

The blades or vanes 120, 130 may likewise have coatings protecting against corrosion or oxidation e.g. (MCrAlX; M is at least one element selected from the group consisting of iron (Fe), cobalt (Co), nickel (Ni), X is an active element and stands for yttrium (Y) and/or silicon and/or at least one rare earth element, or hafnium (HO). Alloys of this type are known from EP 0 486 489 B1, EP 0 786 017 B1, EP 0 412 397 B1 or EP 1 306 454 A1.

The density is preferably 95% of the theoretical density.

A protective aluminum oxide layer (TGO=thermally grown oxide layer) is formed on the MCrAlX layer (as an intermediate layer or as the outermost layer).

The layer preferably has a composition Co-30Ni-28Cr-8Al-0.6Y-0.7Si or Co-28Ni-24Cr-10Al-0.6Y. In addition to these cobalt-based protective coatings, it is also preferable to use nickel-based protective layers, such as Ni-10Cr-12Al-0.6Y-3Re or Ni-12Co-21Cr-11Al-0.4Y-2Re or Ni-25Co-17Cr-10Al-0.4Y-1.5Re.

It is also possible for a thermal barrier coating, which is preferably the outermost layer and consists for example of ZrO₂, Y₂O₃—ZrO₂, i.e. unstabilized, partially stabilized or fully stabilized by yttrium oxide and/or calcium oxide and/or magnesium oxide, to be present on the MCrAlX.

The thermal barrier coating covers the entire MCrAlX layer. Columnar grains are produced in the thermal barrier coating by suitable coating processes, such as for example electron beam physical vapor deposition (EB-PVD).

Other coating processes are possible, for example atmospheric plasma spraying (APS), LPPS, VPS or CVD. The thermal barrier coating may include grains that are porous or have micro-cracks or macro-cracks, in order to improve the resistance to thermal shocks. The thermal barrier coating is therefore preferably more porous than the MCrAlX layer.

Refurbishment means that after they have been used, protective layers may have to be removed from components 120, 130 (e.g. by sand-blasting). Then, the corrosion and/or oxidation layers and products are removed. If appropriate, cracks in the component 120, 130 are also repaired. This is followed by recoating of the component 120, 130, after which the component 120, 130 can be reused.

The blade or vane 120, 130 may be hollow or solid in form. If the blade or vane 120, 130 is to be cooled, it is hollow and may also have film-cooling holes 418 (indicated by dashed lines).

FIG. 5 shows, by way of example, a partial longitudinal section through a gas turbine 100.

In the interior, the gas turbine 100 has a rotor 103 with a shaft 101 which is mounted such that it can rotate about an axis of rotation 102 and is also referred to as the turbine rotor.

An intake housing 104, a compressor 105, a, for example, toroidal combustion chamber 110, in particular an annular combustion chamber, with a plurality of coaxially arranged burners 107, a turbine 108 and the exhaust-gas housing 109 follow one another along the rotor 103.

The annular combustion chamber 110 is in communication with a, for example, annular hot-gas passage 111, where, by way of example, four successive turbine stages 112 form the turbine 108.

Each turbine stage 112 is formed, for example, from two blade or vane rings. As seen in the direction of flow of a working medium 113, in the hot-gas passage 111 a row of guide vanes 115 is followed by a row 125 formed from rotor blades 120.

The guide vanes 130 are secured to an inner housing 138 of a stator 143, whereas the rotor blades 120 of a row 125 are fitted to the rotor 103 for example by means of a turbine disk 133.

A generator (not shown) is coupled to the rotor 103.

While the gas turbine 100 is operating, the compressor 105 sucks in air 135 through the intake housing 104 and compresses it. The compressed air provided at the turbine-side end of the compressor 105 is passed to the burners 107, where it is mixed with a fuel. The mix is then burnt in the combustion chamber 110, forming the working medium 113. From there, the working medium 113 flows along the hot-gas passage 111 past the guide vanes 130 and the rotor blades 120. The working medium 113 is expanded at the rotor blades 120, transferring its momentum, so that the rotor blades 120 drive the rotor 103 and the latter in turn drives the generator coupled to it.

While the gas turbine 100 is operating, the components which are exposed to the hot working medium 113 are subject to thermal stresses. The guide vanes 130 and rotor blades 120 of the first turbine stage 112, as seen in the direction of flow of the working medium 113, together with the heat shield elements which line the annular combustion chamber 110, are subject to the highest thermal stresses.

To be able to withstand the temperatures which prevail there, they may be cooled by means of a coolant.

Substrates of the components may likewise have a directional structure, i.e. they are in single-crystal form (SX structure) or have only longitudinally oriented grains (DS structure).

By way of example, iron-based, nickel-based or cobalt-based superalloys are used as material for the components, in particular for the turbine blade or vane 120, 130 and components of the combustion chamber 110.

Superalloys of this type are known, for example, from EP 1 204 776 B1, EP 1 306 454, EP 1 319 729 A1, WO 99/67435 or WO 00/44949.

The blades or vanes 120, 130 may likewise have coatings protecting against corrosion (MCrAlX; M is at least one element selected from the group consisting of iron (Fe), cobalt (Co), nickel (Ni), X is an active element and stands for yttrium (Y) and/or silicon, scandium (Sc) and/or at least one rare earth element, or hafnium). Alloys of this type are known from EP 0 486 489 B1, EP 0 786 017 B1, EP 0 412 397 B1 or EP 1 306 454 A1.

It is also possible for a thermal barrier coating to be present on the MCrAlX, consisting for example of ZrO₂, Y₂O₃—ZrO₂, i.e. unstabilized, partially stabilized or fully stabilized by yttrium oxide and/or calcium oxide and/or magnesium oxide.

Columnar grains are produced in the thermal barrier coating by suitable coating processes, such as for example electron beam physical vapor deposition (EB-PVD).

The guide vane 130 has a guide vane root (not shown here), which faces the inner housing 138 of the turbine 108, and a guide vane head which is at the opposite end from the guide vane root. The guide vane head faces the rotor 103 and is fixed to a securing ring 140 of the stator 143.

1.-20. (canceled)

21. A masking material, comprising:
a ceramic powder; and
a metallic powder.

22. The masking material as claimed in claim 21, wherein the ceramic powder is an oxide ceramic.

23. The masking material as claimed in claim 22, wherein the oxide ceramic is selected from the group consisting of zirconium oxide, aluminum oxide, titanium oxide, a perovskite, a spinel, a pyrochlore and/or boron nitride, and mixtures thereof.

24. The masking material as claimed in claim 21, wherein the ceramic powder comprises mixtures selected from the group consisting of Al₂O₃/TiO₂, BN/TiO₂, ZrO₂/TiO₂, Al₂O₃/ZrO₂, BN/Al₂O₃ and BN/ZrO₂.

25. The masking material as claimed in claim 21, wherein the ceramic powder comprises only a single ceramic material.

26. The masking material as claimed in claim 21, wherein the metallic powder is selected from the group consisting of nickel, aluminum, cobalt and/or chromium, and mixtures or alloys thereof.

27. The masking material as claimed in claim 21, wherein the metallic powder comprises only a single metallic material.

28. The masking material as claimed in claim 21, wherein the masking material consists of ceramic and metal.

29. The masking material as claimed in claim 21, wherein the masking material comprises only a single ceramic and a single metal.

30. A masking layer, comprising:
a ceramic layer; and
a metallic layer,
wherein the metallic layer is disposed on the ceramic layer.

31. The masking layer as claimed in claim 30, wherein the masking layer comprises at least two ceramic and at least two metallic layers.

32. The masking layer as claimed in claim 31, wherein the at least two ceramic layers and the at least two metallic layers are in an alternating sequence.

33. The masking layer as claimed in claim 30, wherein the masking layer comprises only two metallic and only two ceramic layers.

34. A process for masking a substrate, comprising:
applying a powder layer comprising a ceramic material to the surface of the substrate; and
applying a metallic powder layer to the ceramic layer.

35. The process as claimed in claim 34, wherein the ceramic material is an oxide ceramic.

36. The process as claimed in claim 35, wherein the oxide ceramic is selected from the group consisting of zirconium oxide, aluminum oxide, titanium oxide, a perovskite, and a spinel or pyrochlore and/or boron nitride.

37. The process as claimed in claim 34, wherein only one metal is applied.

38. The process as claimed in claim 34, wherein the powder layer comprising a ceramic material and the metallic powder layer are applied by different processes.

39. The process as claimed in claim 38, wherein the powder layers are applied by brushing, spraying, or dipping.

40. The process as claimed in claim 34, wherein only one ceramic is applied.
